(19) United States
(12) Patent Application Publication
(10) Pub. No.: US 2006/0085449 A1
(43) Pub. Date: Apr. 20, 2006

(54) Method and system for generating presentation materials

(76) Inventors: Juergen Sattler, Wiesloch (DE); Joachim Gaffga, Wiesloch (DE)

Correspondence Address: KENYON & KENYON LLP, 1500 K STREET N.W., SUITE 700, WASHINGTON, DC, 20005, US

(21) Appl. No.: 11/026,055

(22) Filed: Jan. 3, 2005

Related U.S. Application Data
(60) Provisional application No. 60/619,715, filed on Oct. 19, 2004.

(51) Int. Cl. G06F 7/00

(52) U.S. Cl. 707/100

(57) ABSTRACT

A system and method for generating a presentation material is provided. An embodiment of the present invention generates presentation materials using information stored and managed by a software application, such as a Customer Relationship Management (CRM) application. According to one embodiment of the present invention, an operator selects (1) a presentation template and (2) a presentation audience. The template identifies data to be imported from external application. Based on the audience identification, the presentation generator places calls to external applications to export data therefrom and customizes the selected template with the imported data. In this way, embodiments of the present invention may provide a system and method for automatically generating a presentation that may reduce preparation time and human errors.

### CROSS-REFERENCE TO RELATED APPLICATION

This application claims the benefit of priority afforded by provisional application Ser. No. 60/619,715, filed Oct. 19, 2004.

### BACKGROUND

Embodiments of the present invention relate to methods and systems for generating presentation materials. In particular, embodiments of the present invention relate to methods and systems for generating presentation materials automatically using information stored in one or more external applications.

Presentation materials are often generated for various purposes using the information used by and/or stored in different software applications. In such instances, the software application users must manually copy the information used by and/or stored in the software application(s).

A Customer Relationship Management (“CRM”) application is an example. The CRM application stores a large quantity of diverse data that represents a business's interaction with its customers through all phases of the business relationship and measures aspects of customer satisfaction, market penetration, and profitability. The CRM application organizes its data by predetermined categories such as clients, activities, and the like. The CRM application also supports analytic functions, providing reports on, for example, sales volume of a particular business partner. Users might generate presentation materials using data stored in and/or used by the CRM application as a basis.

Many computer operators give the same presentation multiple times but tailor their presentations to different audiences. For example, a salesperson may generate a presentation material for different customers before sales calls. For each customer, the salesperson must customize the presentation materials, which have a common structure, using customer-specific information stored in the CRM application. For example, the presentation materials for all customers may include customer name, graphs representing sales trends, reports identifying pending orders, and the like. Conventionally, the user must manually enter customer specific information for each presentation material using the information stored in the CRM database. This could be time consuming and may also lead to human errors.

Accordingly, there is need in the art for methods and systems for automatically generating presentation materials using information stored in one or more software applications.

### BRIEF DESCRIPTION OF THE DRAWINGS

FIG. 1 illustrates a system for automatically generating presentation materials according to an embodiment of the presentation.

FIG. 2 illustrates a method for automatically generating presentation materials according to an embodiment of the invention.

FIG. 3 illustrates a method for automatically generating presentation materials according to another embodiment of the invention.

FIG. 4 illustrates an exemplary system for generating a presentation material according to an embodiment of the present invention.

### DETAILED DESCRIPTION

An embodiment of the present invention generates presentations using data stored and managed by an external application, such as a Customer Relationship Management (CRM) application. According to one embodiment of the present invention, an operator selects (1) a presentation template and (2) a presentation audience. The template identifies data to be imported from one or more external applications. Based on the audience identification, the presentation generator places calls to external applications to export data therefrom and customizes the selected template with the imported data. In this way, embodiments of the present invention may provide a system and method for automatically generating a presentation that may reduce preparation time and human errors.

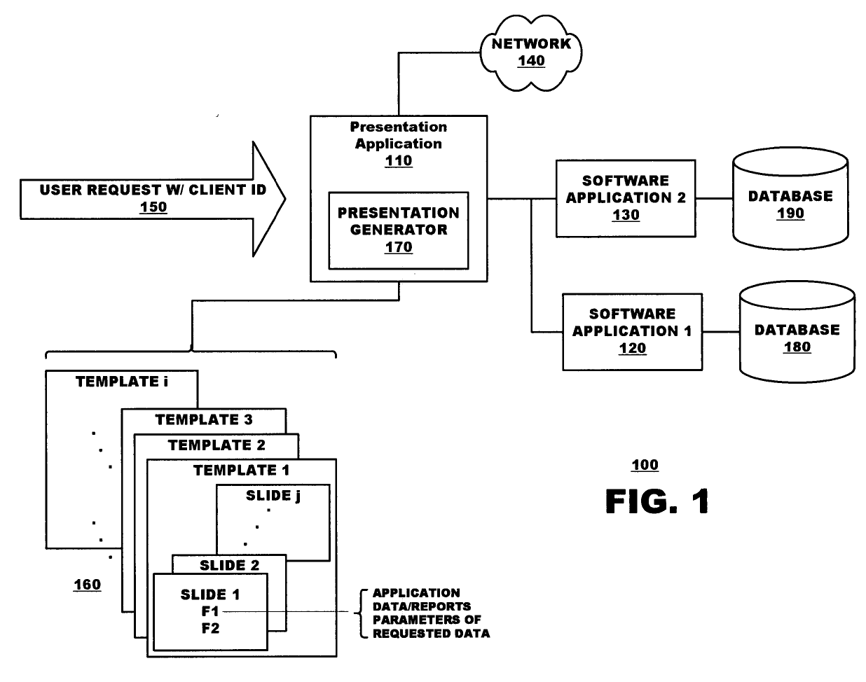

FIG. 1 illustrates a system for automatically generating presentation materials according to an embodiment of the presentation. The system 100 may include a presentation generator application 110, one or more software applications 120, 130, and a network 140. The software applications 120, 130 are external applications, and may communicate with the presentation application 110. The network 140 may support portal-based or web-based communication with other applications (not shown).

The presentation application 110 is an application that permits operators to draft presentations. Microsoft's Powerpoint application is a common example. The presentation application 110 may receive as its input a user request with audience identification 150. The presentation application 110 may include a plurality of templates 160, which define default formats for presentations. Conventionally, operators may build new presentations by creating a new presentation document from a template and editing the presentation to suit the operators' specific needs. In this regard, the operation and functionality of a presentation application 110 is well known.

Embodiments of the present invention propose an automatic presentation generator 170 to expand functionality of ordinary presentation applications. The presentation generator 170 may be integrated with the presentation application or may be provided as a stand-alone application. According to the present invention, presentation templates may include fields therein that identify types of data to be imported therein. The presentation generator 170 reviews the fields within a selected template. With reference to a client identifier provided thereto, the presentation generator 170 may generate queries to other applications within the system to search for the data identified within the template. The presentation generator 170, therefore, automatically imports customer-specific data into a new presentation, thereby avoiding the manual operations that previously were necessary.

The templates 160 may include one or more blank fields provided among the slides. The blank fields may be placeholders for particular data, charts, tables, diagrams, and the like. Throughout the present application, the term “data” may be used to refer to any such information. The blank fields also may identify data to be provided to the presentation categorically. For example, as shown in FIG. 1, the blank fields may specify a software application to import the requested data from and parameters of the requested data and/or reports. Using a client identifier provided thereto, the presentation generator 170 may fashion a query to an external application that specifies data to be imported. When an application furnishes data in response to the query, the presentation generator 170 places the furnished data into the new presentation. Additionally, the blank fields may identify Uniform Resource Locator (URL) addresses of files on a Web server and/or a portal server from which the requested data may be provided. It should be noted that the blank fields contained within a single slide may request data from different external applications, such as various software applications, the portal based network, the Web based network, and/or the like.

Each software application 120, 130 may include a database 180, 190 for storing data organized by pre-determined categories. The database 180, 190 also may store previously generated presentations in relation to the identified audience, or client. In this way, the software application 120, 130 may use these previously generated presentations for various purposes. According to an embodiment of the present invention, the software application 120, 130 may be a Customer Relationship Management (CRM) application, a human resource management application, and/or any other application that may process and store categorized data.

The presentation generator 170 may be invoked from the presentation application 110 itself or from any of the software applications 120, 130. If invoked from the presentation application 110, the presentation generator 170 may provide a user interface that queries the operator to identify a client and a template on which the presentation generator 170 will work. While working with other software applications 120, 130, the applications may include a selection button that allows the user to start the presentation application 110. Some applications, for example CRM applications, permit operators to work on customer accounts. In such systems, client identification may be determined automatically based on a customer account that is open when the presentation generator 170 were launched.

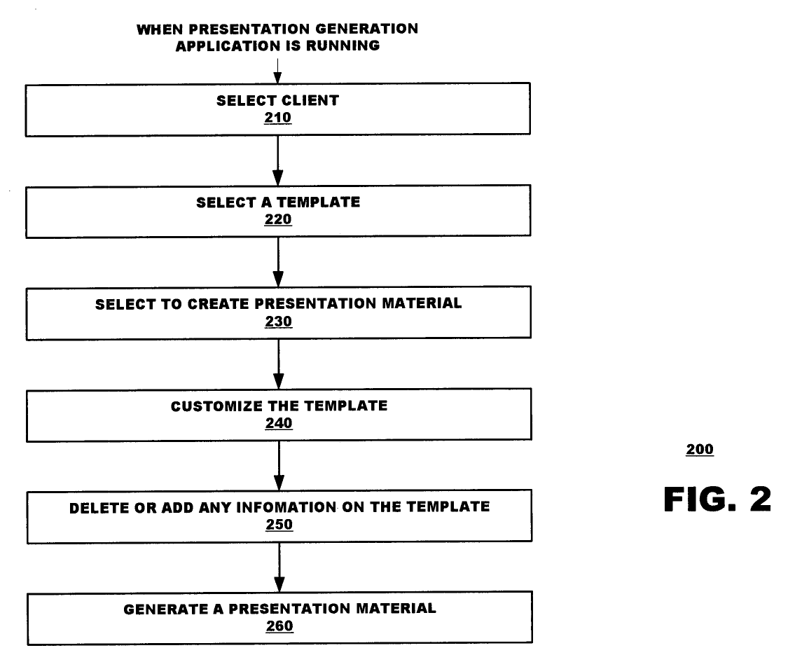

FIG. 2 illustrates a method for automatically generating presentation materials 200 according to an embodiment of the invention. The method 200 may include selecting a client and a template (boxes 210, 220), selecting to create presentation (box 230), customizing a template (box 240), deleting or adding any information to the selected template (box 250), and generating presentation (box 260).

More specifically, the method 200 may begin while the presentation application is running. As mentioned previously, the presentation application may be invoked by the software application or by the user. The method 200 may identify a client, for whom the presentation is intended (box 210). The client may be specified with a client identification number, a client's name, and the like. The method 200 may then select a template to be customized (box 220). Typically, the method 200 may prompt the user to select a template that includes fields identifying data to be provided to the presentation based on the client identification. If, however, there has been only one type of presentation generated for the selected client, the method 200 may automatically retrieve a template associated with the audience based on history and client relationship. The operator may then select to create a presentation material (box 230). According to an embodiment of the present invention, this may be accomplished when the user selects a button provided on the software application's user interface.

When the template is selected, the method 200 may customize the selected template with data imported from external applications, including various software applications and/or networks (box 240). As previously mentioned, the template may include one or more slides, each slide having one or more blank fields that are to be filled in with data imported from one or more external applications. The blank fields may specify data to be imported and the location of such data. When the template is selected, the presentation application may generate a query based on the client identifier and the requested data defined within the blank fields. The presentation generator may then place calls to external software applications and/or networks to export data therefrom.

When the blank field(s) within the selected template is completed, the method 200 may allow the user to delete any undesired information or to add any other desired information in the automatically customized template (box 250). The method 200 may also allow the user to change the format of the presentation material such as its background color, font, text size, and the like. The method 200 may then finish generation of the presentation (box 260).

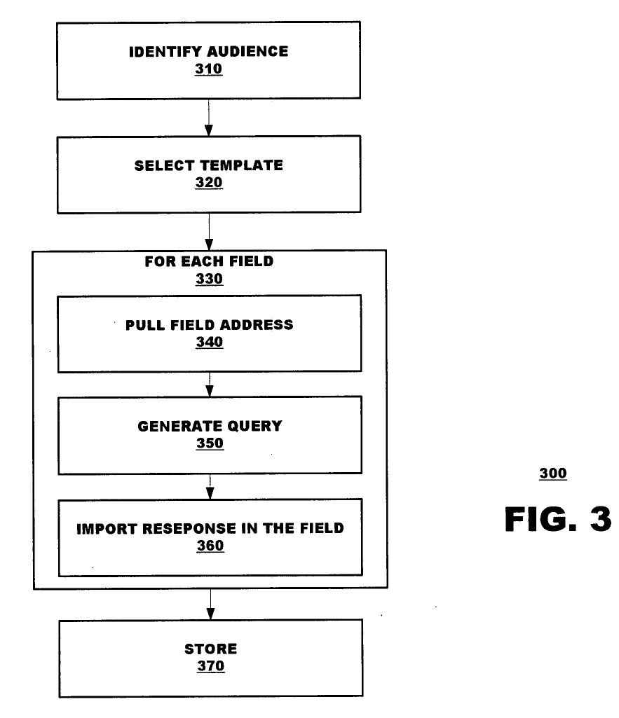

FIG. 3 illustrates a method for automatically generating presentation materials according to another embodiment of the invention. The method 300 may include identifying audience (box 310), selecting a template (box 320), and for each field (box 330): (1) pulling a field address (box 340); (2) generating a query (box 350); and (3) importing a response in the field (box 360), and storing the customized template (box 370).

Particularly, the method 300 may identify an audience according to a user request (box 310). The user request may include audience identification such as a client identification number, a client's name, a client's logo, and the like. The method 300 may select a template to be customized according to the user request (box 320).

The selected template may include one or more slides, each slide having one or more blank fields that are to be filled in with imported data. Thus, the method 300 may survey the selected template for blank fields identifying data to be provided to the presentation. When all of the blank fields within the selected template are found, the method 300 may pull a field address for each blank field (box 340). The field address may include the blank field's identification number, data to be imported, and the location of such data. As previously mentioned, the blank fields within a single slide may required data to be imported from different external applications, such as software applications and networks.

For each blank field, the method 300 may then generate a query to the specified external application based on the audience identification and the field address of the blank field (box 350). The query may be a program that instructs the presentation application to locate the requested data within the specified external application. In particular, the query may place calls on the external application identified in the field address, and search and locate the requested data within the external application.

Once the requested data is located, the method 300 may import the requested data in each blank field (box 360). The method 300 may repeat these processes for each and every blank field within all slides of the selected template (box 330).

When customization of the selected template is completed, the method 300 may store the customized template, or a presentation, within the presentation application (box 370). A copy of the presentation may also be stored in one or more external applications' database with reference to the audience identification.

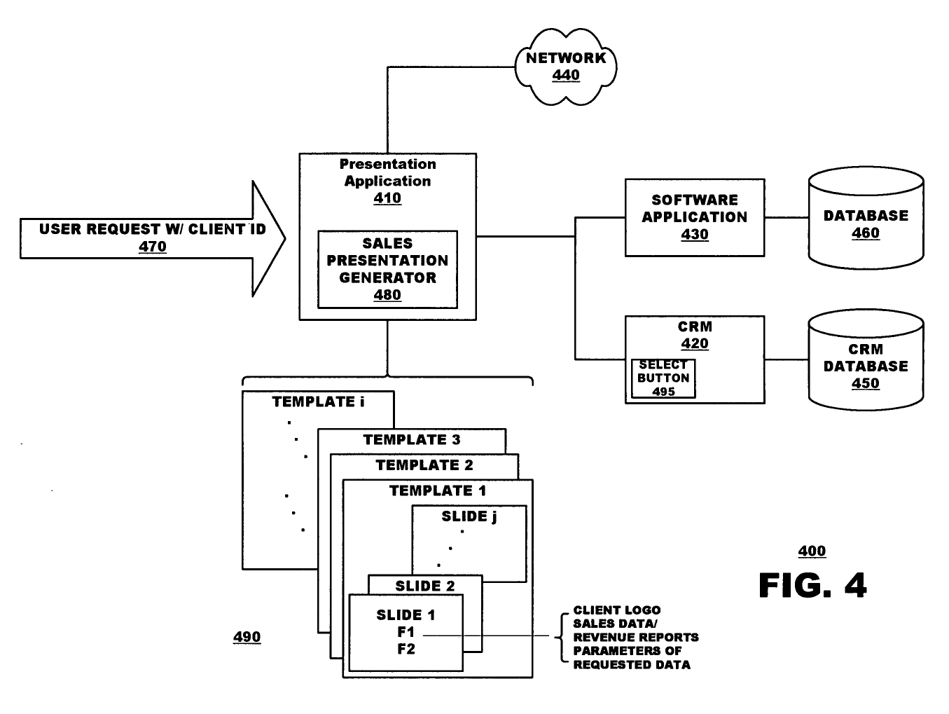

FIG. 4 illustrates an exemplary system for generating a presentation material 400 according to an embodiment of the present invention. The system 400 may include a presentation application 410, a CRM application 420, another software application 430, and a network 440. These external applications may communicate with the presentation application 410. The CRM application 420 may include a database 450, which stores client specific information, such as client names, activities, sales history, client contacts, and the like that are organized by clients. The software application 430 may also include a database 460 for storing categorized data.

The CRM application 420 also may include a select button 495 that allows the operator to select to generate a presentation. For example, while the operator is in a CRM session for a specific client, client A, the operator may select to create a presentation by selecting the select button 495. In such a case, the CRM application 420 may send to the presentation application 410 a user request to generate a presentation for client A. Alternatively, the operator may select to generate a presentation material by selecting a client and a template even if the operator is not in a CRM session.

The presentation application 410 may receive as its input the user request to generate a presentation material with client identification 470. The presentation application 410 may include a sales presentation generator 480, and a plurality of templates 490. The templates 490 may be pre-designed for common purposes and may be customized with the customer specific information stored in the CRM database 420. For example, the template 490 may be pre-designed to create a meeting agenda based on most recently communicated emails with a client, a meeting participant list using the client contact list stored in the CRM database, detailed meeting topics based on recent CRM activities of the client, and the like. As will be readily apparent to those skilled in the art, the template also may be pre-designed for various purposes not specifically mentioned herein.

The template 490 may include one or more slides, each slide having one or more blank fields that are to be filled in with customer specific information. For example, the blank fields may call for customer's name, customer's logo, client contact list, emails communicated with the client, and the like. The blank fields may identify data to be provided to the presentation and the location of the requested data.

When the template is selected, a query may be made to the CRM application based on the client identification and the requested data identified in the blank fields. The sales presentation generator 480 may then place a call to the CRM application 420 to export data therefrom. The presentation application 410 may fill in those blank fields with the customer specific information obtained from the CRM database 450. In this way, the presentation application 410 may automatically generate customized sales presentation materials and allow the user to avoid manually generating similar presentation materials for different clients.

Additionally, the previously generated sales presentation materials may be stored in the CRM database 450 as an attachment to the selected client or business partner. These materials may be attached to the CRM activities. In this way, the CRM operator may use the previously generated sales presentation materials for various purposes, such as automatically creating a meeting invitation. By merging customer specific information with all available and relevant information stored in the CRM application 420, the presentation application 410 will reduce time and human errors in preparing sales calls.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A system for generating a presentation material, comprising:
an external application having a database for storing data organized by predetermined categories; and
a presentation generator for automatically generating a presentation using information stored in the software application database, the presentation generator having a template with one or more blank fields to be customized with the data imported from the external application database.

2. The system of claim 1, wherein the blank fields are customized with data imported from more than one external applications.

3. The system of claim 1, wherein the external application is a Customer Relationship Management application.

4. The system of claim 1, wherein the external application is a software application.

5. The system of claim 1, wherein the external application is a portal based network.

6. The system of claim 1, wherein the external application is a Web based network.

7. The system of claim 1, where the presentation generator generates sales presentation materials.

8. The system of claim 1, wherein the external application database stores customer specific data.

9. The system of claim 1, wherein the presentation may be stored in the external application database.

10. A method for customizing a presentation automatically, comprising:
generating an audience identifier;
surveying a presentation template for fields identifying data to be provided to the presentation; and
for each field,
generating a query to an external application, the query based on the audience identifier and data of the respective field, and
storing data provided in response to the query in the presentation in association with the respective field.

11. The presentation material generator of claim 10, wherein the external application is a Customer Relationship Management application.

12. The presentation material generator of claim 10, wherein the presentation material is a sales presentation material.

13. The presentation material generator of claim 10, wherein the external application database stores customer specific data.

14. A method of generating a presentation, comprising:
receiving a user request with client identification;
selecting a template according to the user request, the template having one or more slides, each slide having at least one blank field to be customized; and
customizing the template by automatically filling in the at least one blank field with data stored in a software application.

15. The method of claim 14, further comprising prompting a user to delete any undesired information from the customized template.

16. The method of claim 14, further comprising prompting a user to add any desired information to the customized template.

17. The method of claim 14, wherein the template is selected by a user.

18. The method of claim 14, wherein the template is automatically selected according to the user request.
